(19) United States
(12) Patent Application Publication
(10) Pub. No.: US 2019/0235745 A1
(43) Pub. Date: Aug. 1, 2019

(54) METHOD AND DEVICE FOR DISPLAYING DESCRIPTIVE INFORMATION

(71) Applicant: Xiaomi Inc., Beijing (CN)

(72) Inventors: Daokuan LIU, Beijing (CN); Shuai LIU, Beijing (CN); Xinyan XING, Beijing (CN); Chunhe YANG, Beijing (CN); Yao TANG, Beijing (CN)

(21) Appl. No.: 16/377,261

(22) Filed: Apr. 8, 2019

Related U.S. Application Data
(63) Continuation of application No. 14/668,985, filed on Mar. 26, 2015.
Application No. 14/668,985 is a continuation of application No. PCT/CN2015/071259, filed on Jan. 21, 2015.

(30) Foreign Application Priority Data
Oct. 24, 2014 (CN) 201410575749.9

(51) Int. Cl. G06F 3/0484; G06F 9/451; G06F 3/0481

(52) U.S. Cl. CPC G06F 3/04847; G06F 3/04817; G06F 9/453

(57) ABSTRACT

The present disclosure relates to a method and a device for displaying descriptive information. The method includes: hiding descriptive information of an application icon on a screen interface of a terminal device; determining whether a request for viewing the descriptive information from a user exists according to whether a trigger operation on an application icon on the screen interface is detected; determining the request for viewing exists, if the trigger operation on any one application icon is detected; and displaying corresponding descriptive information of the application icon in a connected region if the request exists. Accordingly, by hiding descriptive information of application icons, a screen of a terminal device may keep neat when a user does not want to view the descriptive information; meanwhile, the descriptive information may be displayed promptly on the screen of the terminal when it is detected that the user requests for viewing the descriptive information.

### CROSS-REFERENCE TO RELATED APPLICATION

This application is a Continuation of U.S. application Ser. No. 14/668,985, filed on Mar. 26, 2015, which is a Continuation of International Application No. PCT/CN2015/071259, filed Jan. 21, 2015, which is based upon and claims priority to Chinese Patent Application No. CN201410575749.9, filed Oct. 24, 2014, the entire content of which are incorporated herein by reference.

### TECHNICAL FIELD

The present disclosure generally relates to the field of terminal device technology, and more particularly, to a method and a device for displaying descriptive information.

### BACKGROUND

With the progressive development of terminal technology, users may install various application programs in terminal devices, which may implement versatile functions, to meet demands in business, entertainment and the like. With regard to the application programs installed by the users, corresponding icon information may be displayed on screens of the terminal devices. Corresponding application programs may be run upon detection of selection and triggering of users on the icon information. The icon information involves application icons and descriptive information of the application icons for the user to identify corresponding application programs.

### SUMMARY

Embodiments of the present disclosure provide a method, a device and a non-transitory storage medium for displaying descriptive information.

According to a first aspect of embodiments of the present disclosure, there provides a method for displaying descriptive information, comprising: hiding descriptive information of an application icon on a screen interface of a terminal device; determining whether a request for viewing the descriptive information from a user exists according to whether a trigger operation on an application icon on the screen interface of the terminal device is detected; determining the request for viewing exists, if the trigger operation on any one application icon is detected; and displaying corresponding descriptive information of the application icon in a connected region if the request exists.

According to a second aspect of embodiments of the present disclosure, there provides a device for displaying descriptive information, comprising: a processor; and a memory for storing instructions executable by the processor, wherein the processor is configured to perform: hiding descriptive information of an application icon on a screen interface of a terminal device; determining whether a request for viewing the descriptive information from a user exists according to whether a trigger operation on an application icon on the screen interface of the terminal device is detected; determining the request for viewing exists, if the trigger operation on any one application icon is detected; and displaying corresponding descriptive information of the application icon in a connected region if the request exists.

According to a third aspect of embodiments of the present disclosure, there provides a non-transitory storage medium having stored therein instructions that, when executed by one or more processors of a device for displaying descriptive information, causes the device to perform: hiding descriptive information of an application icon on a screen interface of a terminal device; determining whether a request for viewing the descriptive information from a user exists according to whether a trigger operation on an application icon on the screen interface of the terminal device is detected; determining the request for viewing exists, if the trigger operation on any one application icon is detected; and displaying corresponding descriptive information of the application icon in a connected region if the request exists.

The technical solutions provided by the embodiments of the present disclosure include advantageous effects as follows: in the present disclosure, by hiding descriptive information of application icons, a screen of a terminal device may keep neat when a user does not want to view the descriptive information; meanwhile, the descriptive information may be displayed promptly on the screen of the terminal when it is detected that the user requests for viewing the descriptive information, so as to avoid influencing operation efficiency of the user, and to improve user experience.

It is to be understood that both the foregoing general description and the following detailed description are exemplary and explanatory only and can not limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for displaying descriptive information, according to an exemplary embodiment;

FIG. 2 is a flow chart showing another method for displaying descriptive information, according to an exemplary embodiment;

FIG. 3 is a schematic diagram of the interface of a terminal device according to an exemplary embodiment;

FIG. 4 is a flow chart showing another method for displaying descriptive information, according to an exemplary embodiment;

FIG. 5 is another schematic diagram of the interface of a terminal device according to an exemplary embodiment;

FIG. 6 is another schematic diagram of the interface of a terminal device according to an exemplary embodiment;

FIG. 7 is a block diagram illustrating an apparatus for displaying descriptive information, according to an exemplary embodiment;

FIG. 8 is a block diagram illustrating another apparatus for displaying descriptive information, according to an exemplary embodiment;

FIG. 9 is a block diagram illustrating another apparatus for displaying descriptive information, according to an exemplary embodiment;

FIG. 10 is a block diagram illustrating another apparatus for displaying descriptive information, according to an exemplary embodiment;

FIG. 11 is a block diagram illustrating another apparatus for displaying descriptive information, according to an exemplary embodiment; and

FIG. 12 is a block diagram illustrating the configuration of a device for displaying descriptive information, according to an exemplary embodiment.

### DETAILED DESCRIPTION

Reference may now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

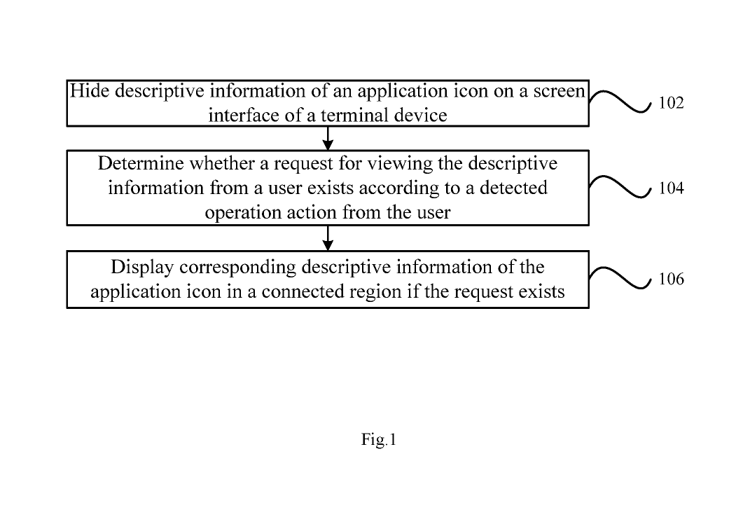

FIG. 1 is a flow chart showing a method for displaying descriptive information, according to an exemplary embodiment. As shown in FIG. 1, the method is applied in a terminal device, and may include the following steps.

In step 102, descriptive information of an application icon on a screen interface of a terminal device is hidden.

In this embodiment, due to increasingly higher identifiability of an application icon itself, by hiding descriptive information of an application icon, the screen interface of the terminal device may only contain the application icon, thus presenting a neat and uniform overall displaying effect, and may not influence identification and distinguish of the application icon.

In step 104, it is determined whether a request for viewing the descriptive information from a user exists according to a detected operation action from the user.

In this embodiment, with respect to some application icons that are not easy to be identified, when a request for viewing corresponding descriptive information from the user exists, the request may be reflected on the operation action from the user. Therefore, by analyzing the operation action from the user, it may be determined whether a request for viewing descriptive information exists. If it is determined that the request for viewing descriptive information exists, the descriptive information may be promptly displayed, so as to present an excellent user experience.

In step 106, corresponding descriptive information is displayed in a connected region of the application icon if the request exists.

In this embodiment, the connected region of the application icon may refer to: a region located surrounding the application icon with a distance to an edge of the application icon, less than or equal to a preset distance, so that a user may directly determine the connection between the application icon and the descriptive information in the region by using his visual system.

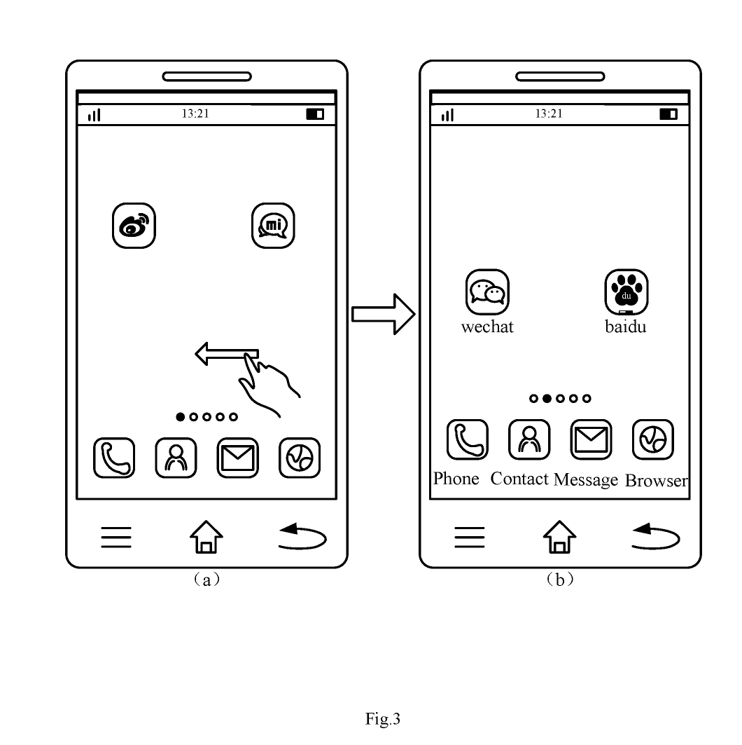

For example, as shown in FIG. 3, the descriptive information of the application icon may be a name of the application icon, and the connected region of the application icon may be a region right below the application icon for displaying the name thereof. In an illustrative way, in FIGS. 3, 5 and 6, the descriptive information is displayed, for example, below the application icon, but the present disclosure is not limited thereto.

In this embodiment, “a request for viewing the descriptive information from the user exists” may be taken as a trigger condition. Thus only if the trigger condition is satisfied, it is determined to perform subsequent operations, leaving out cases where the trigger condition is not satisfied. However, “a request for viewing the descriptive information from the user exists” may also be taken as a judgment condition. When the judgment condition is satisfied, it is determined to perform subsequent operations, otherwise the state is unchanged and other operations may be performed.

It can be seen from the above embodiment that, in the present disclosure, the descriptive information of the application icons is hidden by default. By automatically detecting a request for viewing the descriptive information from the user, the descriptive information may be promptly displayed when the corresponding user request exists, so as to avoid influencing on operation efficiency of the user and to improve user experience.

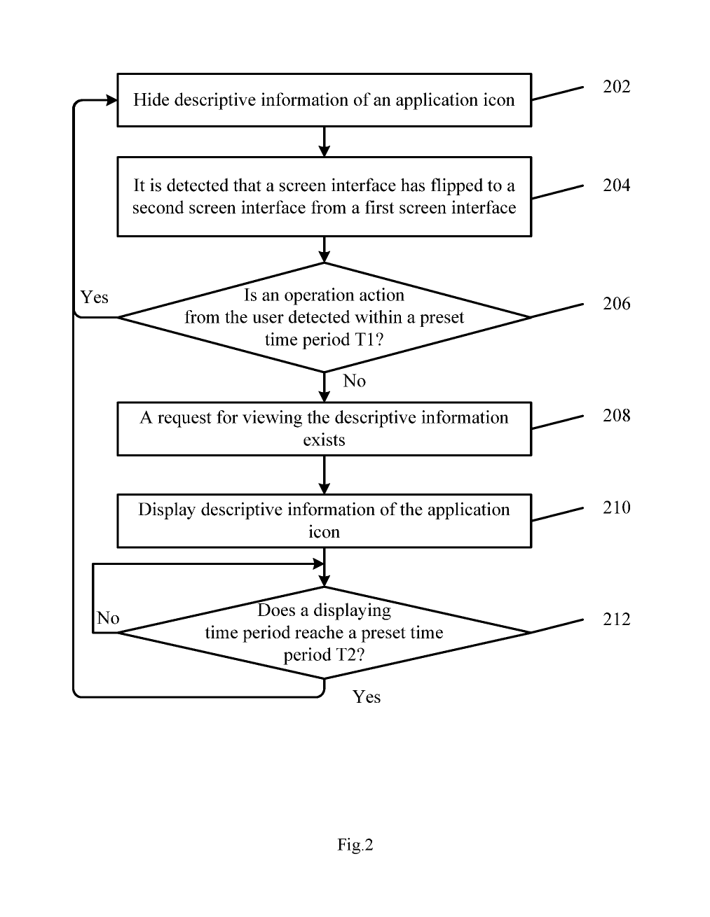

Refer to FIG. 2, which is a flow chart showing another method for displaying descriptive information, according to an exemplary embodiment, the method includes the following steps.

In step 202, descriptive information of an application icon is hidden.

In this embodiment, the technical solution of the present disclosure may be taken as a special display mode or a display function. Thus when a user turns on the mode or the function in a terminal system, the method for displaying descriptive information based on the technical solution of the present disclosure may be implemented; or, when the user turns on other display modes or functions, corresponding display effects may be implemented, such as always displaying or hiding the descriptive information.

In this embodiment, FIG. 3(a) shows a screen interface where descriptive information is hidden. A user may directly determines that the two application icons at the top of the screen interface respectively correspond to “Sina Microblog” and “Mi Talk”, the four application icons at the bottom of the screen interface respectively correspond to “telephone”, “contact”, “short message” and “browser”.

In step 204, when it is detected that the screen interface has flipped to a second screen interface from a first screen interface by the user, the process is turned to step 206.

In this embodiment, an initial first screen interface is shown in FIG. 3(a), since it is not detected that a request for viewing the descriptive information from the user at this time, descriptive information corresponding to all of the application icons is hidden. Herein the descriptive information may be a name of the application program corresponding to the application icon, and may also be other information for describing the application program, which is not limited by the present disclosure.

In step 206, it is determined whether an operation action from the user is detected within a preset duration T1. If it is not detected, the process is turned to step 208, otherwise, the process is returned to step 202.

In this embodiment, FIG. 3(a) shows a first screen on the screen of the terminal device (5 dots at the bottom of the interface indicate 5 screen interfaces on the screen of the terminal device, among which a dark one indicates the current screen interface), i.e. the first screen interface. When the user performs a swipe operation gesture on the first screen interface, a second screen as shown in FIG. 3(b), i.e. the second screen interface, is entered.

Herein, when a user performs a page-flipping operation, it often means that he/she is searching for a certain application and intends to start it. If a direct identification of the application icon is completed and it is determined that the proper application icon is found, the application icon may be directly hit to start the application after the screen interface has flipped to the second screen interface by the user as shown in FIG. 3(b). Alternatively, if there is no icon of the application that the user is searching for in the second screen interface, the user may continue to perform the page-flipping operation or the like.

Accordingly, if the user directly identifies the application icon, corresponding operations may be performed. While, if the application icon is not identified, the user may probably take a pause to consider the meaning of the application icon, which results in that no operation of the user is detected within a long duration (for example, longer than or equal to a preset duration T1).

In step 208, it is determined whether a request for viewing the descriptive information from a user exists.

In step 210, descriptive information of the application icon is displayed.

In this embodiment, as shown in FIG. 3(b), the descriptive information may be displayed below the corresponding application icon, such that the user may directly determine the connection between the descriptive information and the application icon.

In this embodiment, as an exemplary embodiment, all of the application icons on the terminal device may be uniformly displayed, so as to simplify the setting of the terminal device. As another exemplary embodiment, since the user produces a long duration of pause in browsing the second screen interfaces, it may probably means that the user is considering about a certain application icon on the second screen interface. In this case, only descriptive information of the application icons on the second screen interface is displayed, while descriptive information of application icons on other screen interfaces is not displayed. As yet another embodiment, it may also be detected which application icon the user concerns much, for example, by acquiring information on the sight of the user through a camera and the like on the terminal device, to determine the application icon of interest based on a position of the focus of the sight of the user (i.e. the application icon corresponding to user operation behaviors such as “the focus of the sight of the user”), so that the descriptive information of the application icon may be displayed individually.

In step 212, when a displaying duration of the descriptive information reaches a preset duration T2, the process is returned to step 202.

In this embodiment, depending on the displaying duration of the descriptive information, the process is automatically returned to step 202, that is, resuming hiding the descriptive information, thereby it may be avoided that the descriptive information is displayed for a long time, and the screen interface of the terminal device may be resumed to be neat promptly.

In this embodiment, the displaying duration of the descriptive information may be counted, and compared with the preset duration T2, to determine the flow of the process; or, “a displaying duration reaching a preset duration T2” may be set as a trigger condition by setting up a timer, thus once the condition is satisfied, the process is returned to step 202.

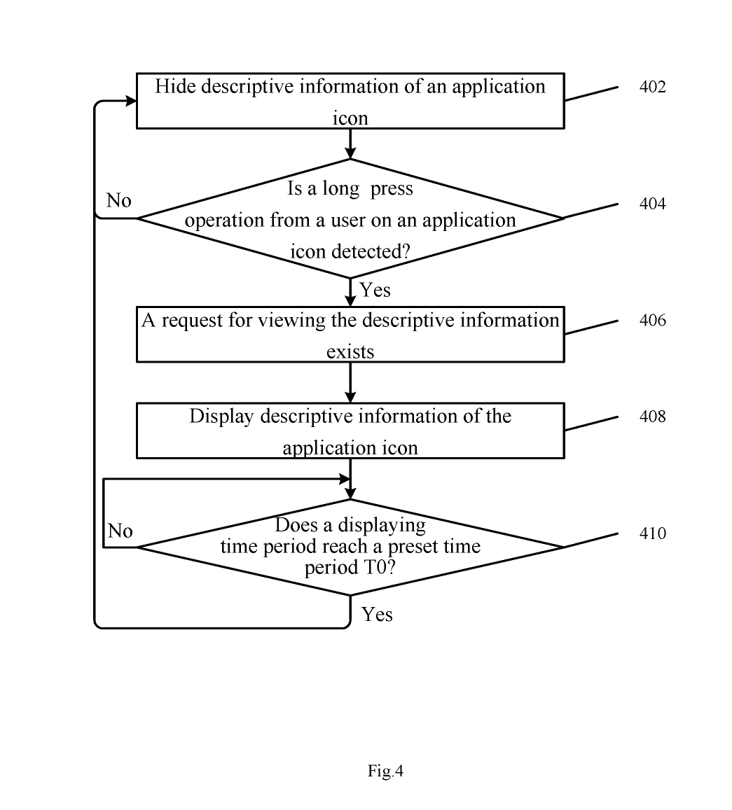

Refer to FIG. 4, which is a flow chart showing another method for displaying descriptive information, according to an exemplary embodiment, the method includes the following steps.

In step 402, descriptive information of an application icon is hidden.

In step 404, when a long press operation from a user on a certain application icon on the screen interface of the terminal device is detected, the process is turned to step 406.

In this embodiment, “a long press operation from a user on a certain application icon on the screen interface of the terminal device is detected” may be taken as a trigger condition, and only if this trigger condition is satisfied, it is determined to perform subsequent operations, leaving out cases where the trigger condition is not satisfied. However, “a long press operation from a user on a certain application icon on the screen interface of the terminal device is detected” may also be taken as a judgment condition, and when the judgment condition is satisfied, it is determined to perform subsequent operations, otherwise the state is unchanged and other operations may be performed.

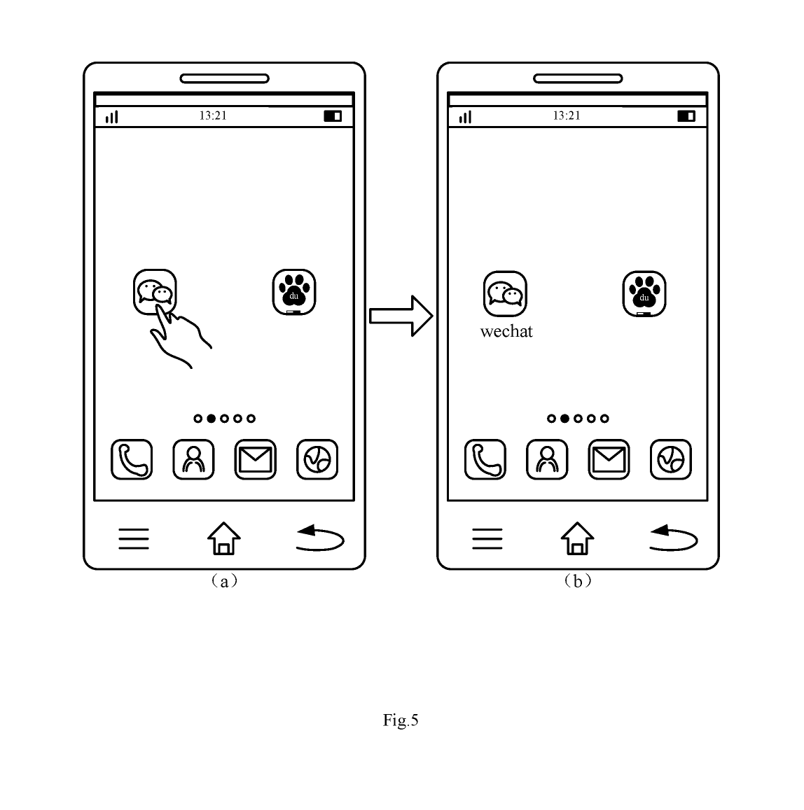

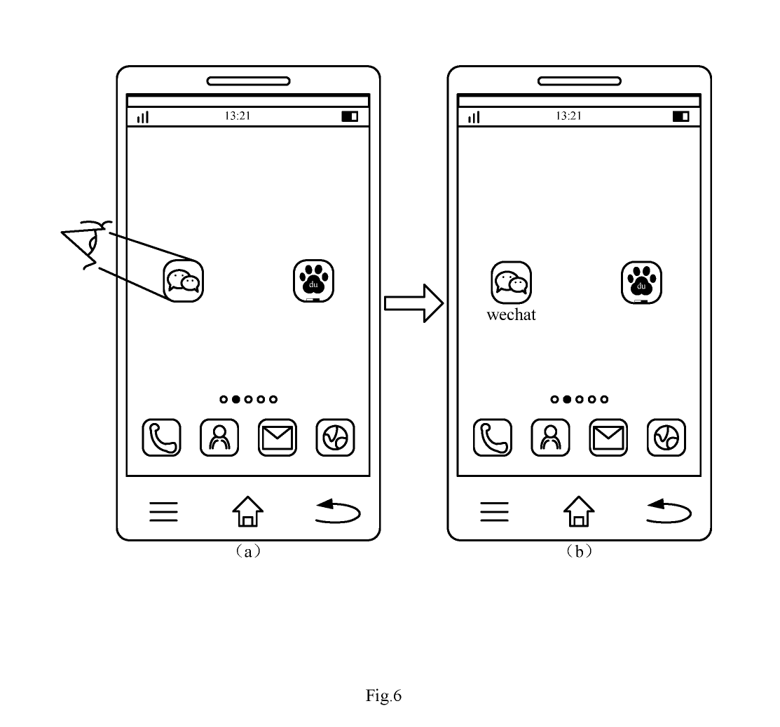

In this embodiment, as shown in FIG. 5(a), when the user intends to view descriptive information of a certain application icon, he/she may trigger the application icon by a long press, and then the descriptive information may be displayed. However, it should be understood by those skilled in the art that, in addition to a long press, a trigger operation may be implemented by other manners. For example, the trigger operation may be implemented by detecting a shake operation action to the terminal device by the user, or as shown in FIG. 6(a), for example, the trigger operation may be implemented by detecting a focus of the sight of the user, and taking the application icon corresponding to the position of the focus as an application icon of interest; or, the trigger operation may be implemented by a combination with information of a duration, so as to reduce mis-trigger, for example, only when the sight of the user is focused on a certain application icon for a duration exceeding a preset duration it is determined that the user is interested in the application icon.

In step 406, it is determined whether a request for viewing the descriptive information from a user exists.

In step 408, descriptive information of the application icon is displayed.

In this embodiment, as an exemplary embodiment, all of the application icons on the terminal device may be uniformly displayed, so as to simplify the setting of the terminal device; as another exemplary embodiment, only descriptive information of all of the application icons on the screen interface where the triggered application icon is located may be displayed, and descriptive information of application icons on other screen interfaces is not displayed; as yet another exemplary embodiment, such as an application icon “wechat” in FIG. 5(b) and FIG. 6(b), only descriptive information of application icons triggered by a long press or focus of the sight of the user (that is, application icons corresponding to “a long press”, “a focus of sight” and other operation actions from the user, such as the above application icon “wechat”) may be displayed, to minimize the displayed descriptive information and the influence on the overall display effect of the screen interface.

In step 410, when a displaying duration of the descriptive information reaches a preset duration T0, the process is returned to step 402.

In this embodiment, depending on the displaying duration of the descriptive information, the process is automatically returned to step 402, that is, resuming the hiding of the descriptive information, thereby it may be avoided that the descriptive information is displayed for a long time, and the screen interface of the terminal device may be resumed to be neat promptly.

In this embodiment, the displaying duration of the descriptive information may be counted, and compared with the preset duration T0, to determine the flow of the process; or, “a displaying duration reaching a preset duration T0” may be set as a trigger condition by setting up a timer, thus once the condition is satisfied, the process is returned to step 402.

Corresponding to the foregoing embodiments of the method for displaying descriptive information, the present disclosure also provides embodiments of a device for displaying descriptive information.

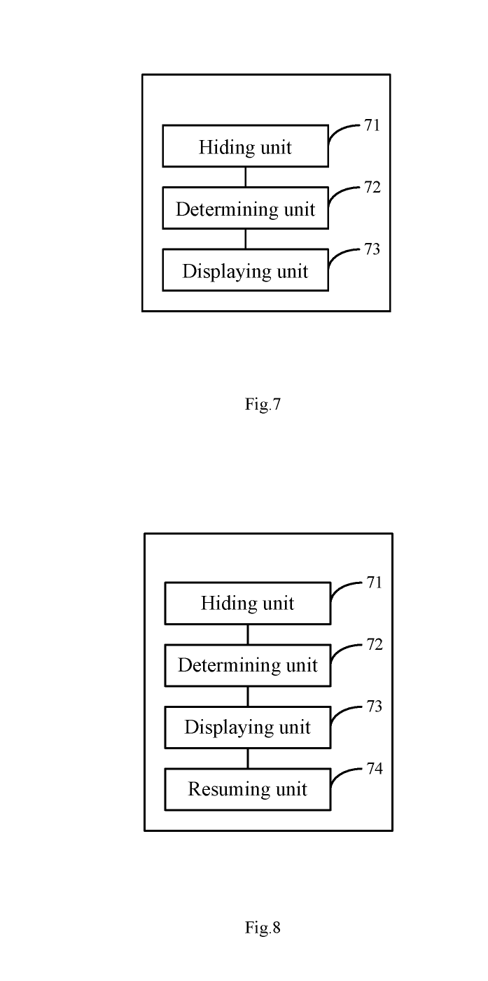

FIG. 7 is a block diagram illustrating an apparatus for displaying descriptive information, according to an exemplary embodiment. Referring to FIG. 7, the apparatus includes a hiding unit 71, a determining unit 72 and a displaying unit 73.

Herein, the hiding unit 71 is configured to hide descriptive information of an application icon on a screen interface of a terminal device; the determining unit 72 is configured to determine whether a request for viewing the descriptive information from a user exists according to a detected operation action from the user; and the displaying unit 73 is configured to display corresponding descriptive information in a connected region of the application icon if a determination result obtained by the determining unit is that the request exists.

In the above embodiment, by hiding descriptive information of application icons, a screen of a terminal device may keep neat when a user does not want to view the descriptive information; meanwhile, the descriptive information may be displayed promptly on the screen of the terminal device when it is detected that the user requests for viewing the descriptive information, so as to avoid influencing on operation efficiency of the user, and to improve the user experience.

As shown in FIG. 8, FIG. 8 is a block diagram illustrating another apparatus for displaying descriptive information, according to an exemplary embodiment, in which, based on the embodiment shown in FIG. 7, the apparatus may further include a resuming unit 74.

Wherein the resuming unit 74 is configured to resume the hiding of the descriptive information when a displaying duration of the descriptive information reaches a first preset duration.

In the above embodiment, by controlling a displaying duration of the descriptive information, the influence, caused by the descriptive information, on the displaying effect of the screen interface of the terminal device may be reduced, so as to improve user experience.

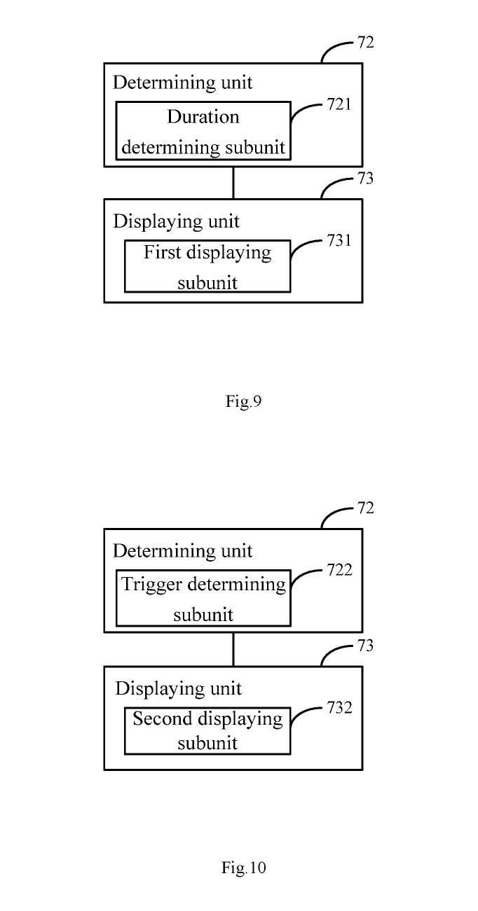

As shown in FIG. 9, FIG. 9 is a block diagram illustrating another apparatus for displaying descriptive information according to an exemplary embodiment, in which, based on the embodiment above shown in FIG. 7, the determining unit 72 may include a duration determining subunit 721, and the displaying unit 73 may include a first displaying subunit 731.

In this case, the duration determining subunit 721 is configured to determine whether a request for viewing the descriptive information from a user exists according to whether an operation action from the user is detected within a second preset duration, after detecting that the screen interface has flipped to a second screen interface from a first screen interface by the user, wherein, if no operation action from the user is detected, it is determined that the request for reviewing exists; and the first displaying subunit 731 is configured to display corresponding descriptive information in respective connected region of respective application icon on the second screen interface, if a determination result obtained by the duration determining subunit 721 is that the request for viewing exists.

In the above embodiment, after the user identifies the application icon, he/she may perform a certain operation, and a long duration of pause in operation may occur only when the user cannot properly identify the application icon and is thinking about it, thus a request for viewing the descriptive information from the user may be identified according thereto.

In this case, when a pause in operation from the user occurs in the second screen interface, it means that the user is considering the type of the application icon on the second screen interface and a request for viewing the descriptive information from the user exists, thus only the descriptive information of the application icons on the second screen interface needs to be displayed, and the descriptive information of the application icons on other screen interfaces needs not to be displayed.

It should be noted that, configuration of the duration determining subunit 721 and the first displaying subunit 731 in the embodiment of the apparatus shown above in FIG. 9 may also be included in the apparatus embodiments shown above in FIGS. 7 and 8, which is not limited by the present disclosure.

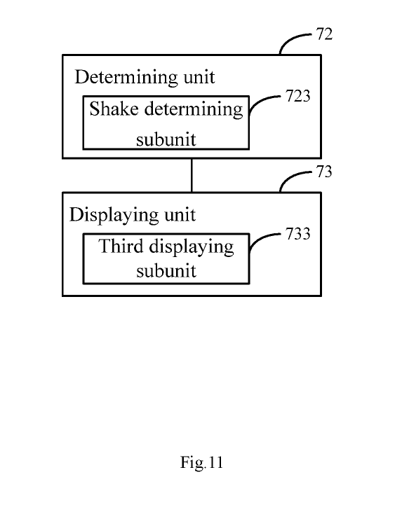

As shown in FIG. 10, FIG. 10 is a block diagram illustrating another apparatus for displaying descriptive information according to an exemplary embodiment, in which, based on the embodiment shown above in FIG. 7, the determining unit 72 may include a trigger determining subunit 722, and the displaying unit 73 may include a second displaying subunit 732.

In this case, the trigger determining subunit 722 is configured to determine whether a request for viewing the descriptive information from a user exists according to whether a trigger operation on an application icon on the screen interface of the terminal device is detected, wherein, if a trigger operation on any application icon is detected, it is determined that the request for reviewing exists; and the second displaying subunit 732 is configured to display corresponding descriptive information in a connected region of any of the aforesaid application icon, if a determination result obtained by the trigger determining subunit 722 is that the request for viewing exists.

In the above embodiment, when the user intends to view descriptive information of a certain application icon, he/she may directly trigger on the application icon, thereby a explicit request for viewing the corresponding application icon from the user may be determined by detecting the trigger operation.

In this case, when a trigger operation on a certain application icon from the user is detected, it means that the user has explicitly expressed a request for viewing the descriptive information of the application icon, thus only the descriptive information of the application icon needs to be displayed to satisfy the demand of the user, and minimize the influence to the neatness of the screen of the terminal device.

It should be noted that, configuration of the trigger determining subunit 722 and the second displaying subunit 732 in the above apparatus embodiment as shown in FIG. 11 may also be included in the apparatus embodiments shown above in FIGS. 7 and 8, which is not limited by the present disclosure.

As shown in FIG. 11, FIG. 11 is a block diagram illustrating another apparatus for displaying descriptive information according to an exemplary embodiment, in which, based on the embodiment shown above in FIG. 7, the determining unit 72 may include a shake determining subunit 723, and the displaying unit 73 may include a third displaying subunit 733.

Herein, the shake determining subunit 723 is configured to determine whether a request for viewing the descriptive information from a user exists according to whether a shake operation action to the terminal device is detected, wherein, if the shake operation action is detected, it is determined that the request for reviewing exists; and the third displaying subunit 733 is configured to display corresponding descriptive information in each connected region of each application icon, if a determination result obtained by the shake determining subunit 723 is that the request for viewing exists.

In the above embodiment, descriptive information of an application icon may be displayed directly according to a detected user request for viewing, so as to simplify the setting of the terminal device; or corresponding application icons, i.e. application icons a user may be interested in, may also be determined by the operation behavior of the user, thereby only descriptive information of these application icons is displayed, so as to reduce influence to the overall neatness on the screen of the terminal device and the display effect.

It should be noted that, configuration of the shake determining subunit 723 and the third displaying subunit 733 in the above apparatus embodiment as shown in FIG. 11 may also be included in the apparatus embodiments shown above in FIGS. 7 and 8, which is not limited by the present disclosure.

With respect to the apparatus in the above embodiments, specific operations performed by each modules have been described in detail in the embodiments of related method, and detailed description are omitted here.

For the apparatus embodiments, since they substantially correspond to the method embodiments, relevant part may be referred to the description of the method embodiments. The above described apparatus embodiments are only illustrative, in which units described as separate components may be or may not be separate physically, components shown as units may be or may not be physical units, and they may be located at one place or may be distributed to a plurality of network units. It may be understood and practiced by those skilled in the art without paying any creative labor that part or all of the modules may be selected as desired to achieve the objects of the solutions of the present disclosure.

Correspondingly, the present disclosure also provides an information displaying device, including: a processor; and a memory for storing instructions executable by the processor, wherein the processor is configured to: hide descriptive information of an application icon on a screen interface of a terminal device; determine whether a request for viewing the descriptive information from a user exists according to a detected operation behavior of the user; and display corresponding descriptive information in a connected region of the application icon if the request exists.

Correspondingly, the present disclosure also provides a terminal device, including a memory and one or more programs, wherein the one or more programs are stored in the memory, and configured to be executable by one or more processors, wherein the one or more programs include instruction to cause operations as follows: hiding descriptive information of an application icon on a screen interface of a terminal device; determining whether a request for viewing the descriptive information from a user exists according to a detected operation action from the user; and displaying corresponding descriptive information in a connected region of the application icon if the request exists.

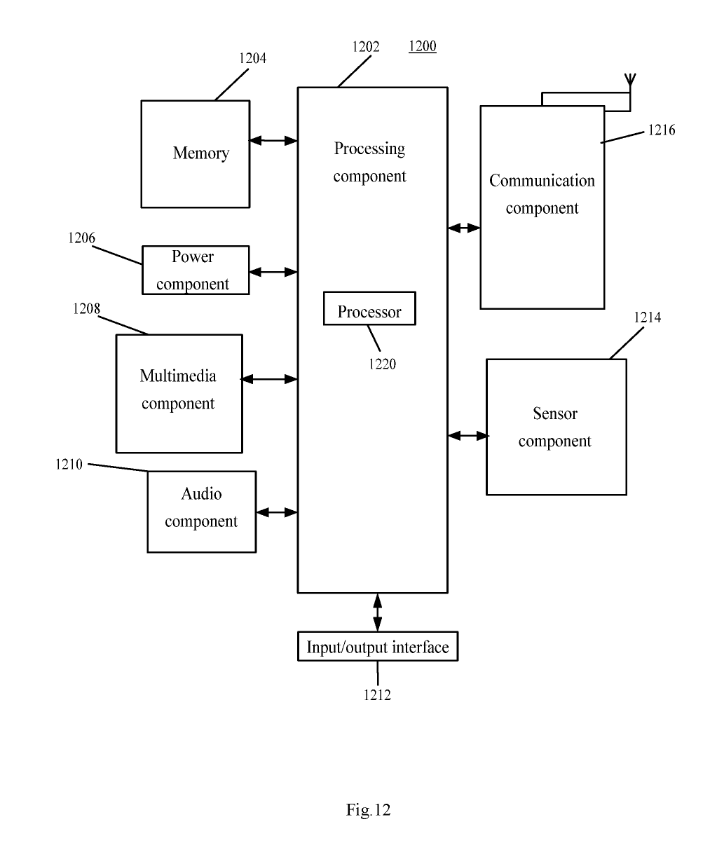

FIG. 12 is a block diagram illustrating a device 1200 for displaying descriptive information, according to an exemplary embodiment. For example, the device 1200 may be a mobile phone, a computer, a digital broadcast terminal, a messaging device, a gaming console, a tablet device, a medical device, an exercise equipment, a personal digital assistant, and the like.

Referring to FIG. 12, the device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the device 1200, such as the operations associated with display, telephone calls, data communications, camera operations, and recording operations. The processing component 1202 may include one or more processors 1220 to execute instructions to perform all or part of the steps in the above described methods. Moreover, the processing component 1202 may include one or more modules to facilitate the interaction between the processing component 1202 and other components. For instance, the processing component 1202 may include a multimedia module to facilitate the interaction between the multimedia component 1208 and the processing component 1202.

The memory 1204 is configured to store various types of data to support the operation on the device 1200. Examples of such data include instructions for any applications or methods operated on the device 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the device 1200. The power component 1206 may include a power management system, one or more power sources, and any other components associated with the generation, management, and distribution of power in the device 1200.

The multimedia component 1208 includes a screen providing an output interface between the device 1200 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 1208 includes a front camera and/or a rear camera. The front camera and the rear camera may receive an external multimedia datum while the device 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the device 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the device 1200. For instance, the sensor component 1214 may detect an open/closed status of the device 1200, relative positioning of components, e.g., the display and the keypad, of the device 1200, a change in position of the device 1200 or a component of the device 1200, a presence or absence of user contact with the device 1200, an orientation or an acceleration/deceleration of the device 1200, and a change in temperature of the device 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the device 1200 and other devices. The device 1200 can access a wireless network based on a communication standard, such as WiFi, 2Q or 3Q or a combination thereof. In one exemplary embodiment, the communication component 1216 receives a broadcast signal or broadcast associated information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, to perform the above described methods.

In exemplary embodiments, there is also provided a non-transitory computer-readable storage medium including instructions, such as included in the memory 1204, executable by the processor 1220 in the device 1200, for performing the above-described methods. For example, the non-transitory computer-readable storage medium may be a ROM, a RAM, a CD-ROM, a magnetic tape, a floppy disc, an optical data storage device, and the like.

Other embodiments of the disclosure may be apparent to those skilled in the art from consideration of the specification and practice of the disclosure disclosed here. This application is intended to cover any variations, uses, or adaptations of the disclosure follow the general principles thereof and including such departures from the present disclosure as come within known or customary practice in the art. It is intended that the specification and examples be considered as exemplary only, with a true scope and spirit of the disclosure being indicated by the following claims.

It may be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for displaying descriptive information, comprising:
hiding descriptive information of an application icon on a screen interface of a terminal device;
determining whether a request for viewing the descriptive information from a user exists according to whether a trigger operation on an application icon on the screen interface of the terminal device is detected;
determining the request for viewing exists, if the trigger operation on any one application icon is detected; and
displaying corresponding descriptive information of the application icon in a connected region if the request exists.

2. The method of claim 1, further comprising:
resuming the hiding of the descriptive information when a displaying duration of the descriptive information reaches a first preset duration.

3. The method of claim 1, wherein the trigger operation comprises a long press operation.

4. The method of claim 1, wherein displaying the corresponding descriptive information in the connected region comprises:
displaying the corresponding descriptive information in the connected region surrounding the application icon with a preset distance to an edge of the application icon.

5. The method of claim 1, wherein the corresponding descriptive information is a name of the application icon.

6. A device for displaying descriptive information, comprising:
a processor; and
a memory for storing instructions executable by the processor,
wherein the processor is configured to perform:
hiding descriptive information of an application icon on a screen interface of a terminal device;
determining whether a request for viewing the descriptive information from a user exists according to whether a trigger operation on an application icon on the screen interface of the terminal device is detected;
determining the request for viewing exists, if the trigger operation on any one application icon is detected; and
displaying corresponding descriptive information of the application icon in a connected region if the request exists.

7. The device of claim 6, wherein the processor is configured to further perform:
resuming the hiding of the descriptive information when a displaying duration of the descriptive information reaches a first preset duration.

8. The device of claim 6, wherein the trigger operation comprises a long press operation.

9. The device of claim 6, wherein displaying the corresponding descriptive information in the connected region comprises:
displaying the corresponding descriptive information in the connected region surrounding the application icon with a preset distance to an edge of the application icon.

10. The device of claim 6, wherein the corresponding descriptive information is a name of the application icon.

11. A non-transitory storage medium having stored therein instructions that, when executed by one or more processors of a device for displaying descriptive information, causes the device to perform:
hiding descriptive information of an application icon on a screen interface of a terminal device;
determining whether a request for viewing the descriptive information from a user exists according to whether a trigger operation on an application icon on the screen interface of the terminal device is detected;
determining the request for viewing exists, if the trigger operation on any one application icon is detected; and
displaying corresponding descriptive information of the application icon in a connected region if the request exists.

12. The non-transitory storage medium of claim 11, wherein the device is further caused to perform:
resuming the hiding of the descriptive information when a displaying duration of the descriptive information reaches a first preset duration.

13. The non-transitory storage medium of claim 11, wherein the trigger operation comprises a long press operation.

14. The non-transitory storage medium of claim 11, wherein displaying the corresponding descriptive information in the connected region comprises:
displaying the corresponding descriptive information in the connected region surrounding the application icon with a preset distance to an edge of the application icon.

15. The non-transitory storage medium of claim 11, wherein the corresponding descriptive information is a name of the application icon.
